(19) United States
(12) Patent Application Publication
(10) Pub. No.: US 2010/0129141 A1
(43) Pub. Date: May 27, 2010

(54) TRANSVERSE LONGITUDINAL JOINT

(75) Inventors: Miguel Angel Gonzalez Alemany, Oviedo (ES); Iván Ruiz Patallo, Gijon (ES); José Ojeda Arenas, Gijon (ES)

Correspondence Address: MERCHANT & GOULD PC, P.O. BOX 2903, MINNEAPOLIS, MN, 55402-0903, US

(73) Assignees: THYSSENKRUPP ELEVATOR INNOVATION CENTER, S.A., Gijon (ES); THYSSENKRUPP ELEVATOR (ES/PBB) GmbH., Essen (DE)

(21) Appl. No.: 12/582,383

(22) Filed: Oct. 20, 2009

(30) Foreign Application Priority Data
Oct. 20, 2008 (ES) 200802952

(51) Int. Cl. F16B 7/00

(52) U.S. Cl. 403/50

(57) ABSTRACT

Transverse longitudinal joint comprising slats (11) with a main shaft (11e), a passable surface (11s), a functional surface (11f) opposite to the passable one (11s), connecting sides between the passable (11s) and the functional (11f) surfaces. Slats are mounted one after the other according to the main shaft (11e) to form a bellows structure, with a displacement movement without break in continuity with 2 degrees of freedom, so as to modify the bellows shape between an unfolded position and a folded position. Slats form a retractable surface (1). Each intermediate slat (11) has joining elements having: a male end (11A) in a first connecting side; a female end (11B) in a second connecting side, opposite to the first connecting side; the female end (11B) receives the male end (11A) of an adjacent slat (11).

This application claims benefit of Ser. No. 200802952, filed Oct. 20, 2008 in Spain and which application is incorporated herein by reference. To the extent appropriate, a claim of priority is made to the above disclosed application.

### FIELD OF THE INVENTION

The present invention relates to transverse longitudinal joints which can be used as expansion joints between elements which can be subject to small displacements among them, for example due to assembly tolerances or operation temperature differences, or as a joint in a landing area of an escalator or a moving walkway.

### BACKGROUND OF THE INVENTION

There already exist in the prior art moving walkways or escalators that avoid the use of the, usually necessary, pit for their installation. This type of device may be installed directly on the floor, incorporating a small access ramp, or inside a pit of minimum dimensions. Moving walkways and escalators whose combs are as horizontal as possible to improve the user's safety are also well known. However, these construction characteristics make the internal design of the machine differ from that of a conventional escalator or moving walkway. The present invention proposes a construction solution for this type of installations.

### DESCRIPTION OF THE INVENTION

Unlike any moving walkway or escalator driven by a chain transmission, in this type of moving walkway the chain is the band of pallets itself. Said band of pallets, like any transmission chain, needs to be tightened both in the installation of the moving walkway or escalator and regularly during the corresponding maintenance tasks. In a conventional moving walkway or escalator, the chain tightening device is hidden under the floor plates, inside the pit of the lower end or lower landing platform (because the motor is placed at the other end). In the aforementioned transportation devices, the tightening system is completely different because they practically lack a pit, and the band of pallets is the transmission chain, and because they also incorporate a horizontal comb plate so as to minimize the step at both ends of the device (improving the user's comfort and safety).

A first aspect of the invention relates to a transverse longitudinal joint comprising a plurality of slats which have a main shaft, a passable surface, a functional surface opposite to the passable surface, connecting sides between the passable surface and the functional surface, where the slats are:
mounted one after the other according to the main shaft to form a bellows structure, where the slats have displacement movement without break in continuity with 2 degrees of freedom, to modify the shape of the bellows between an unfolded position, where the joint has a maximum width/length and a folded position, where the joint has a minimum width/length:
   a first degree of longitudinal freedom, DF 1, perpendicular to the main shaft;
   a second degree of transverse freedom, DF 2, parallel to the main shaft; arranged so as to form a retractable surface, where each intermediate slat has connecting means comprising:
   a male end in a first connecting side, being the male end arranged to be received by;
   a female end on a second connecting side, opposite to the first connecting side, being the female end arranged to receive a male end of an adjacent slat.

A second aspect of the invention relates to a transportation system for carrying people/goods comprising a longitudinal joint such as the one described hereinabove in a landing area.

### BRIEF DESCRIPTION OF THE DRAWINGS

There follows a brief description of a series of drawings that will help to better understand the invention and that are particularly related to an embodiment of said invention presented as a non-limiting example thereof.

FIG. 1 shows the joint of the invention used in a landing area of a moving walkway or escalator.

FIGS. 2A, 2B show the slats and the bars connecting them at the functional surface.

FIG. 3A shows a section perpendicular to the main shaft with the joint in an intermediate position between the unfolded and folded position.

FIG. 3B shows a section perpendicular to the main shaft with the joint in a folded position.

FIG. 3C shows the first joints of the bars to the slats and second joints of the bar among themselves.

FIG. 3D shows the lateral covers linking the slats.

FIG. 4 shows a joint where the elastic means comprise springs and guides.

FIG. 5 shows the first support means.

FIG. 6 shows the second support means.

FIG. 7 shows the folding/unfolding means to wind/unwind the slat-like joint.

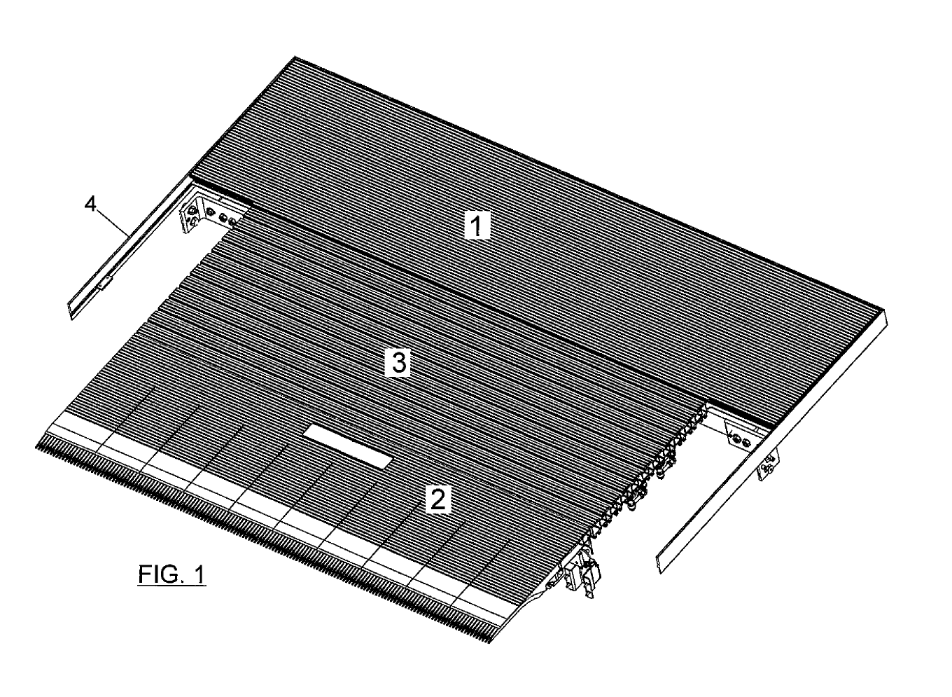

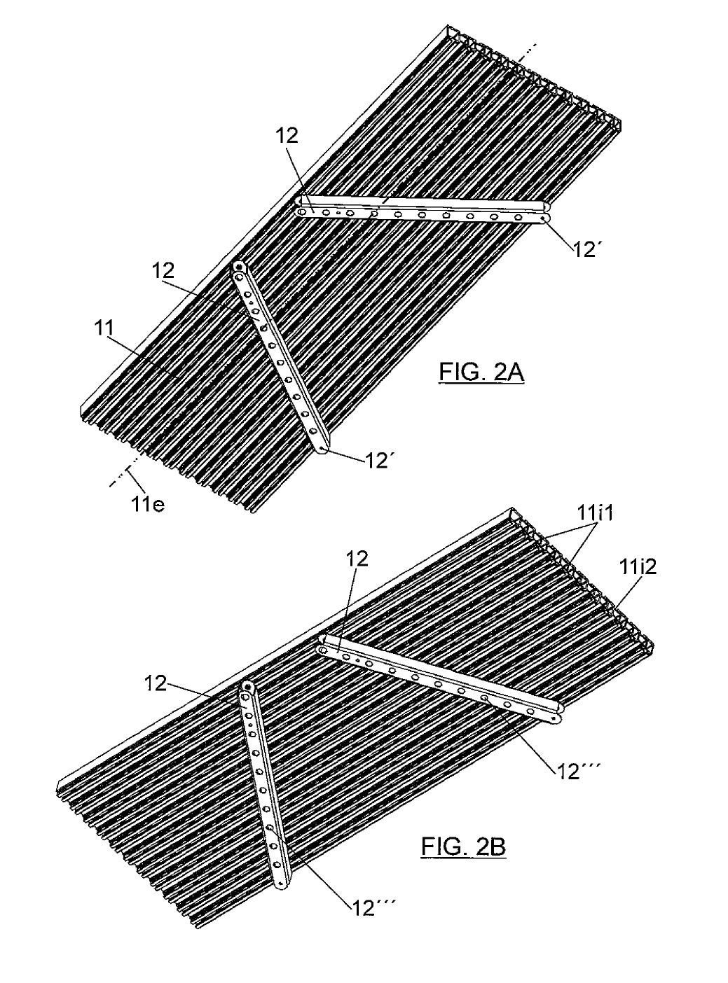

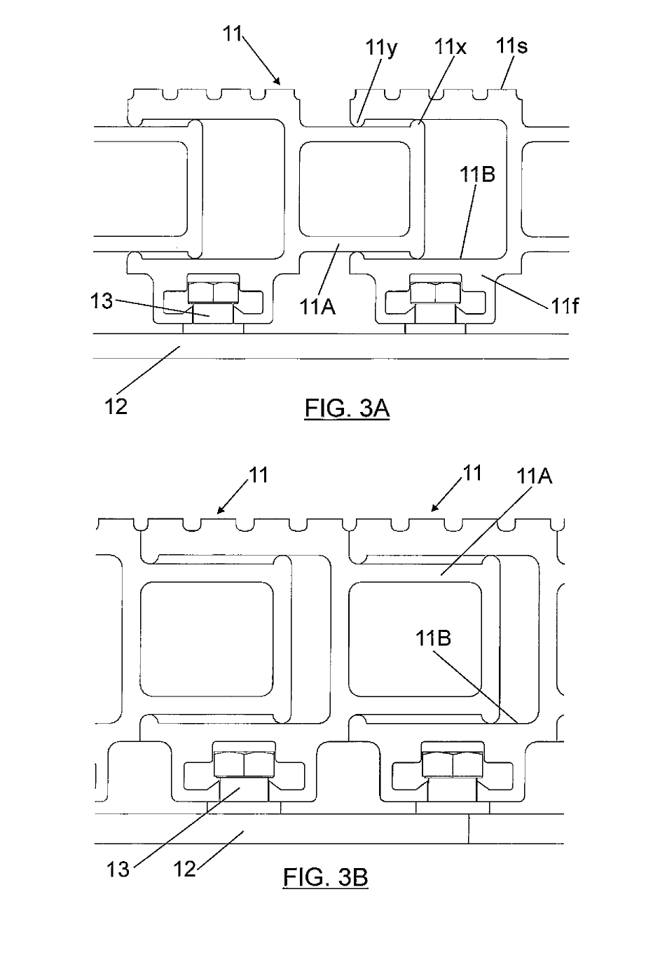

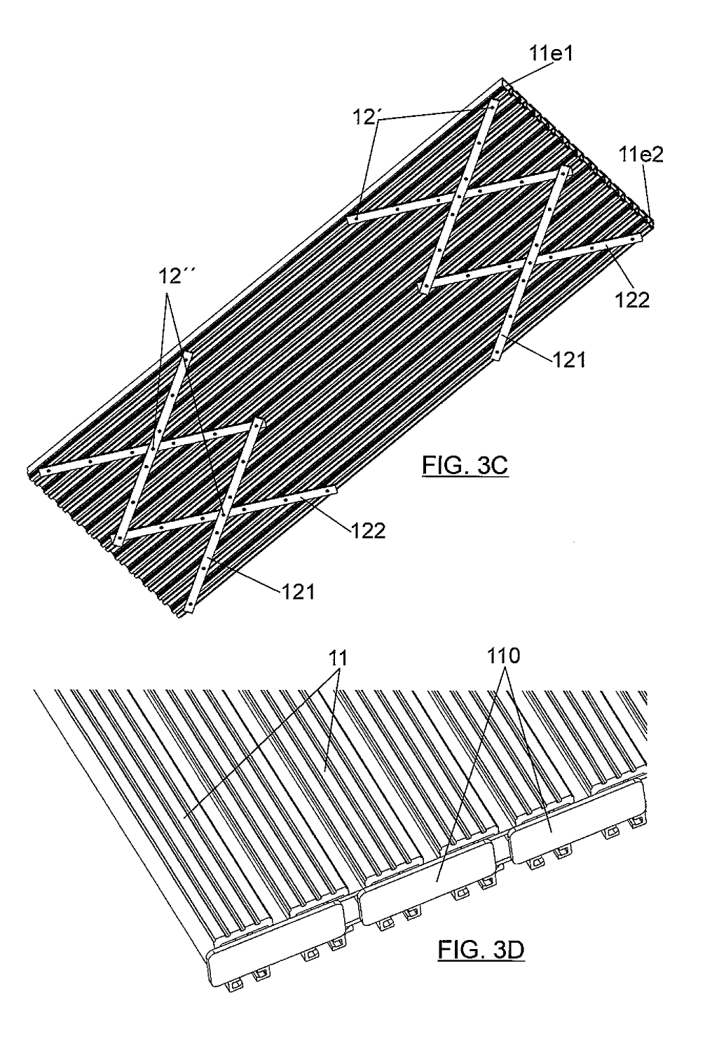

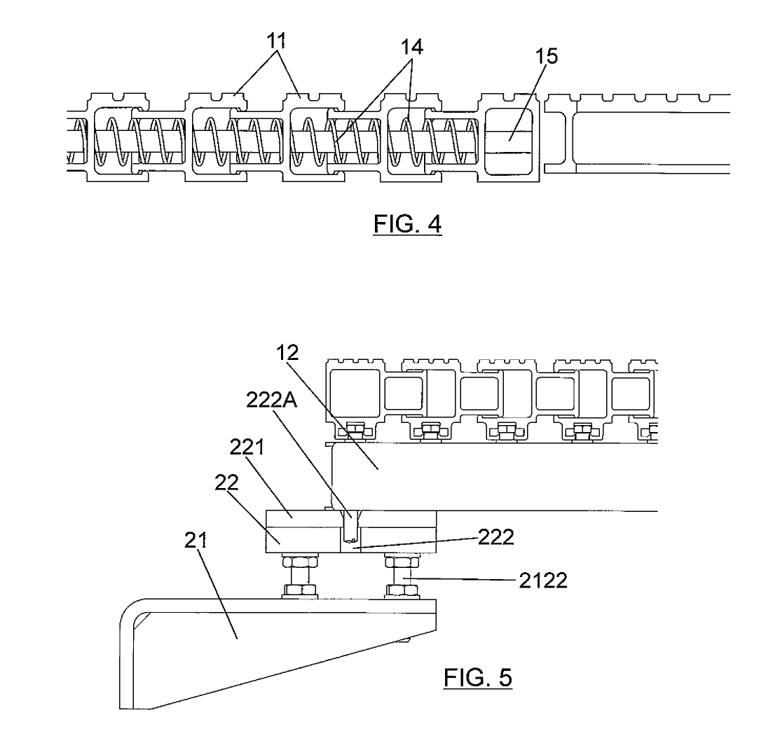

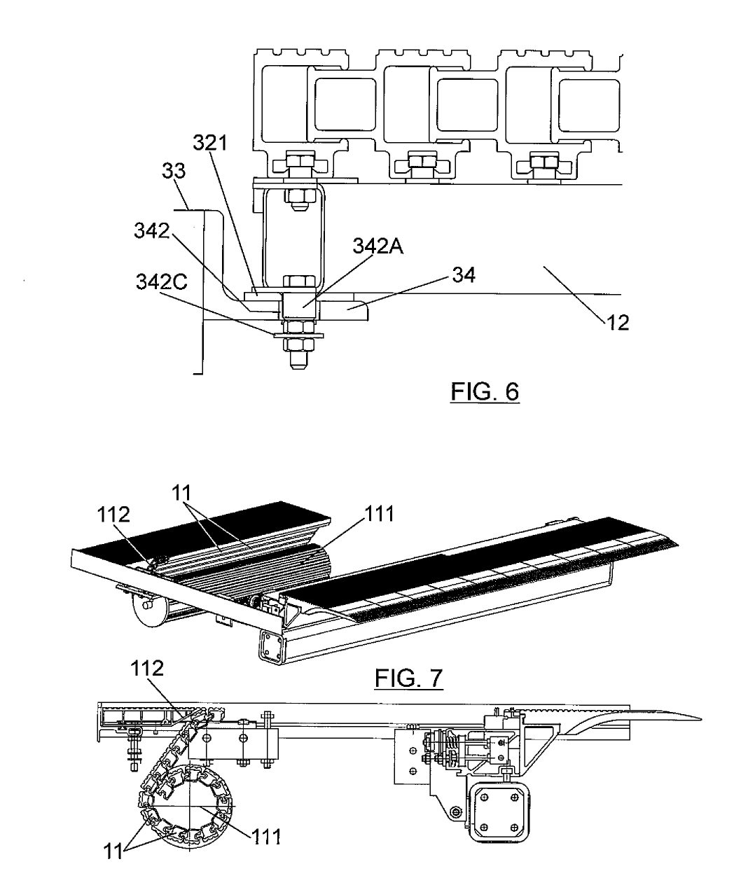

### DESCRIPTION OF A PREFERRED EMBODIMENT OF THE INVENTION

We can summarize that the problem is that when the band of pallets is tightened and released (thus producing a length increase and decrease), the guiding circuit of said pallets is modified (it will have a larger length when it is tightened and vice versa) and, if the comb plate (2) does not move towards the tightening or releasing direction, respectively it will interfere with the new path of said pallets or there will be a gap between the walk-on surface before the comb plate and the band of pallets.

In the tightening case, this reversing produces a reduction of the dimensions of the floor plate at the exit landing platform, making it necessary to foresee a sort of expansion joint capable of absorbing said increase/reduction of the cover length because the frame (4) installation is fixed and cannot be changed in terms of length, according to the longitudinal shaft of the way, once they are installed. The height of said cover must be adjustable because, for assembly reasons, the frames-covers are adjusted in height until the cover surface is perfectly made flush with the passable surface of the comb plate, and therefore avoid “bumps.” The expansion joint has to absorb the distance that the band of pallets is calculated to form after the necessary tightening.

The design of the entrance landing platform cover comprises two pieces, a conventional cover (3) and a so-called retractable one (1), which is the one that absorbs the length variations during the tightening/releasing.

Said retractable cover (1) comprises a plurality of slats (11) arranged to behave as a blind, being the slats assembled with one another and allowing the relative displacement among themselves.

The frame (4) is fixed and immovable in a direction longitudinal to the walkway, but its height can be adjusted. Therefore, it serves as a mechanical stop for the conventional cover (3). Consequently, said conventional cover (3) constitutes the conceptual stop of the retractable cover (1), since the fixed cover or conventional cover (3) is not the physical stop, but it marks the line that the retractable cover does not have to cross (1). In this way, any variation in the position of the comb plate (2) (bear in mind that the comb plate will be brought backwards when the band of pallets is tightened and vice versa) will reduce or enlarge the retractable cover (1), or in other words, it will make the slats (11) come together or separate from each other since each one can be moved in relation to the others.

In order to ensure that the distance between the slats is always the same, that is, that the distance between the first slat and the second one is always the same as the one between the second and the third . . . and the same as the distance between the n−1 and the n, there are several options:
1. Scissors mechanism: each bar (12) is linked to each slat (11) by means of a sliding joint, if the joint/articulation between the bars is independent from the slides of the slats (11), the scissors mechanism can be applied in the case of an even number of slats; in case of an uneven number of slats, each bar (12) may be linked to each slat (11) except for the middle slat which is the point where the two bars (12) articulate. This mechanism is in turn the supporting structure of the retractable cover (1) and it can present several dispositions:
   a single scissors placed in the middle area of the width of the slats (11);
   two or more serial scissors mechanisms, also placed in the central area to leave a space for a possible fixed frame which help support the cover and the weight of the users walking on it;
   two or more scissors placed on the sides; in case of being more than a pair they will be in a series at each side;
   a small central scissors in a first half of the retractable cover (front part, for example) and two scissors in the second half or rear part.
2. Calipers: variation of the scissors mechanism: two bars (12) articulated in the middle slat. It comprises two bars or sections which can be made of iron (12) and which also perform the function of supporting structure of the walk-on platform.

The slats (11) must have a groove, track or slide in its lower part, so that an element, a slide bolt or bolt (13) can be introduced into them and slide through said groove, track or slide as if it were a railway. In this way, the bar or section (12) is linked to each slat (11) by an element that slides through each one of them except for the middle slat, being it necessary that the slats be uneven in number, or through the initial/final slats, regardless in this case of whether the total number of slats is even or uneven; both sections (12) are articulated in the area where the slats (11) are not joined, in the middle slat or in the initial/final slat. Consequently, analyzing the tightening case when the comb plate (2) is brought backwards, being the direction of the walkway forwards, when it goes backwards the first slat of the retractable cover (1) pulls/pushes the bar or section (12) supporting said cover and, therefore, said section forces each slat (11) to move backwards, except for the last one that is fixed, since it is placed against its mechanical stop, the fixed cover (3).

Since the bar or section (12) are articulated in the middle slat (or in the initial or final one) the bars or the sections will begin to turn around that fixed articulation and, therefore, each element, slide bolt or bolt (13) will move along the runway placed on each slat (11).

In the opposite case (stretching of the band of pallets), the system makes the exactly opposite movement.
3. Slats with an elastic element between them, either a neoprene type (or any foam of that type) or a spring (14). It is an interesting solution if it is assumed that the distance between each slat will not be the same, unless different materials are introduced (or different elastic means) between the slats. In order to ensure the correct alignment of the slats and the appropriate installation of the elastic elements, a pair of bars (15) will be inserted along the slats at each side, and on them there will be mounted in this case the elastic means (14).

As a conclusion and general summary of the invention, and speaking beyond the particular case explained of a rolling walkway or escalator, the transverse longitudinal joint is a surface that is able to provide continuity between two surfaces that experience relative movement between themselves; one of them, static or not, where it can be established a reference coordinate system, which can be called “fixed surface” (3) (in the particular case explained of a walkway or escalator “fixed cover”) and the other, which can be called “movable surface” (2) (in the particular case explained of a walkway or escalator “comb plate”).

A first embodiment of the invention relates to a transverse longitudinal joint comprising a plurality of slats (11) which have a main shaft (11e), a passable surface (11s), a functional surface (11f) opposite to the passable surface (11s), connecting sides between the passable surface (11s) and the functional surface (11f), where the slats are:
mounted or assembled one after the other according to the main shaft (11 e) to form a bellows structure, where the slats (11) have a displacement movement without break in continuity with 2 degrees of freedom, to modify the form of the bellows between an unfolded position, where the joint has a maximum width/length, and a folded position, where the joint has a minimum width/length:
   a first degree of longitudinal freedom, DF 1, perpendicular to the main shaft (11e);
   a second degree of transverse freedom, DF 2, parallel to the main shaft (11e);
arranged to form a retractable surface (1), where each intermediate slat (11) has connecting means comprising:
   a male end (11A) in a first connecting side, being the male end (11A) arranged to be received by;
   a female end (11B) on a second connecting side, opposite to the first connecting side, being the female end (11B) arranged to receive a male end (11A) of an adjacent or contiguous slat (11).

According to other characteristics of the invention:
2) Each intermediate slat (11) also comprises linking means in the male end (11A) and in the female end (11B), comprising:
   first protuberances (11x) parallel to the main shaft (11e) in convex edges of the male end (11A) arranged to slide on an internal surface of the female end (11B);
   second protuberances (11y) parallel to the main shaft (11e) in free ends of the female end (11B) arranged to slide on an external surface of the male end (11A);
      having a clearance between:
   the first protuberances (11x) and the internal surface of the female end (11B); the second protuberances (11y) and the external surface of the male end (11A);
      in order to allow a turn between slats (11) around a shaft parallel to the main shaft (11e) and determine a position of minimum overlapping and a position of maximum overlapping of a slat (11) with an adjacent slat (11).
3) The transverse longitudinal joint also comprises a plurality of bars (12) having:
   first connecting means to join the bars (12) to intermediate slats (11) on the functional surface (11f) by means of a slide having two degrees of freedom without restricting:
      a displacement along a shaft parallel to the main shaft (11e);
      a turn around a shaft perpendicular to the functional surface (11f) of the slat;
   second connecting means to join at least two bars (12) to a same end slat (11ex) on the functional surface (11f) by means of first articulations (12′) that allow a turn around a shaft perpendicular to the functional surface (11f) of the slat;
      to form a cohesion mechanism that maintains a distance between slats (11) in each position of the joint.

In this embodiment, the two bars are joined to the same end slat (11ex).

The bars allow a turn between the slats either because they are flexible bars or because they have a clearance.
4) The transverse longitudinal joint also comprises a plurality of bars (12) having: first connecting means to join the bars (12, 121, 122) to intermediate slats (11) on the functional surface (11f) by means of a slide having two degrees of freedom without restricting:
   a displacement along a shaft parallel to the main shaft (11e);
   a turn around a shaft perpendicular to the functional surface (11f) of the slat;
   second connecting means to join a first bar (121) to a first end slat (11e1) and a second bar (122) to a second end slat (11e2) on the functional surface (11f) by means of first articulations (12′) that allow a turn around shaft perpendicular to the functional surface (11f) of the slats
   third connecting means to join a first bar (121) with a second bar (122) in a second articulation (12″)
      to form a cohesion mechanism that maintains the distance between slats (11) in each position of the joint and so that the cohesion mechanism forms a scissors mechanism.

In this embodiment, a first bar (12) is linked to a first end slat (11e1) and a second bar (12) is linked to a second end slat (11e2).
5) The transverse longitudinal joint also comprises a plurality of bars (12) having:
   first connecting means to join the bars (12) to first intermediate slats (11) on the functional surface (11f) by means of a slide having two degrees of freedom without restricting:
      a displacement along a shaft parallel to the main shaft (11e);
      a turn around a shaft perpendicular to the functional surface (11f) of the slat;
   fourth connecting means to join the bars (12) to a second intermediate slat (11i2) on the functional surface (11f) by means of a third articulation (12′″) that allows a turn around a shaft perpendicular to the functional surface (11f) of the slat (11);
      to form a cohesion mechanism that maintains a distance between slats (11) in each position of the joint.

In this embodiment, the bars (12) are joined to first intermediate slats (11i1) and to a second intermediate slat (11i2).
6) The transverse longitudinal joint also comprises additional cohesion mechanisms placed in a series, one after the other in perpendicular direction to the main shaft (11e), to cover the length of the joint.
7) The transverse longitudinal joint also comprises additional cohesion mechanisms placed in parallel, one after the other in parallel direction to the main shaft (11e), to cover the width of the joint.
8) The transverse longitudinal joint also comprises elastic means (14) on the connecting sides arranged to force the joint to adapt itself to the externally imposed length. The elastic means (14) may be springs or other type of elastic elements such as neoprene foams.
9) The elastic means (14) are compression/pulling springs crossed by guides (15) which also cross all the slats (11).
10) The elastic means (14) are selected from elastic means of equal rigidity and elastic means of different rigidity arranged to maintain a homogenous distance between slats (11).
11) The transverse longitudinal joint also comprises:
   a plurality of side covers (110) to join at least two slats (11) and obtain linked slats (11′) arranged to avoid a relative displacement of linked slats (11′) in the direction of the main shaft (11e).
12) The transverse longitudinal joint also comprises folding/unfolding means to wind/unwind the joint as a blind, comprising:
   a winding roller (111) parallel to the main shaft (11e) beneath the passable surface (11s) arranged to withdraw an excess section of the joint of the retractable surface (1);
   a folding/unfolding guide (112) at each lateral end of the slats (11) in a perpendicular plane to the main shaft (11e) to guide the slats (11) in the folding/unfolding process between the winding roller (111) and the retractable surface (1).

The folding/unfolding guide (112) may be part of the fixed cover (3) or not, and is arranged to minimize the groove between the fixed and the retractable covers, to provide the passable surface with continuity. Likewise, the compression force of the successive slats pushes the next ones when the retractable surface shortens, and the pushing force when it unfolds, when a slat pulls the following one.

The transverse longitudinal joint also comprises torsion means to force a tendency towards winding on the winding roller (111) of the excess section of the joint.
13) The transverse longitudinal joint also comprises first supporting means comprising:
   a first support (21) integral to the movable surface (2);
   a second support (22) integral on the first support (21) comprising:
   a low-friction material layer (221) on which the bars (12) rest.
14) The transverse longitudinal joint also comprises first interconnection means, which can be a hole or a splitting (222) parallel to the main shaft (11e) to interconnect, insert or guide a first pin (222A) of the bar (12).
15) The first pin (222A) also comprises a low-friction material ferrule to facilitate the slide movement of the first pin (222A) in the first splitting (222).
16) The transverse longitudinal joint also comprises second supporting means comprising:
   a third support (33):
   on which the fixed surface rests (3)
   a fourth support (34) jointly joined to the third support (33) comprising:
   a low-friction material layer (321) on which the bars (12) rest.
17) The fourth support (34) also comprises second interconnection means which may be a hole or a splitting (342) parallel to the main shaft (11e) to interconnect, insert or guide a second pin (342A) of the bar (12) and to become the physical stop joint and so that a final end of the joint does not move when the bellows structure moves between the unfolded and folded positions.
18) The second pin (342A) also comprises a low-friction material ferrule to facilitate the slide movement of the second pin (342A) in the second splitting (342).
19) The second pin (342A) also comprises a lock washer (342C) which constitutes a latch to avoid a dismantling of the joint by people alien to the installation.

The front and rear supports fulfill two functions:
1—serving as a support for the bars so that the loads are transferred to the rest of the walkway structure (in this case the bars fulfill the functions of supporting structure);
2—when the bars articulate in the middle slat, both the bar-slat initial/final articulation allows the sliding movement of the slats, therefore when the bars rest on said supports (front-rear), the supports have to allow the slide movement of the bars on them;
3—the front support will push the bars so that the expansion joint begins to shorten (or will pull from them so that they begin to expand), and the rear support is fixed to serve as a mechanical stop. In this case and for mounting reasons, the comb plate does not push the first slat but the bar “pushes” the first slat in its corresponding articulation; likewise, and in order to ensure certain clearance between the fixed cover and the retractable one, it is not said fixed cover the one that acts as a “real” mechanical stop but the rear support; in this way it is ensured that there exists a groove of a couple of millimeters between the retractable cover and the fixed one and thus it is possible to easily dismantle the fixed cover to have access to the machine. Without that groove the retractable cover might compress the fixed cover against the frame, which might make it impossible to extract the fixed cover.
20. Another embodiment of the invention relates to a transportation system for carrying people/goods comprising a longitudinal joint such as the one described hereinabove in a landing area.

1. Transverse longitudinal joint wherein it comprises a plurality of slats comprising a main shaft, a passable surface, a functional surface opposite to the passable one, connecting sides between the passable and the functional surfaces, wherein the slats are:
mounted one after the other according to the main shaft to form a bellows structure,
wherein the slats have a displacement movement without break in continuity with 2 degrees of freedom, to modify the form of the bellows between an unfolded position, where the joint has a maximum width/length, and a folded position, where the joint has a minimum width/length:
a first degree of longitudinal freedom, DF 1, perpendicular to the main shaft;
a second degree of transverse freedom, DF 2, parallel to the main shaft;
arranged to form a retractable surface, wherein each intermediate slat has connecting means comprising:
a male end in a first connecting side, being the male end arranged to be received by;
a female end on a second connecting side, opposite to the first connecting side, being the female end arranged to receive a male end of an adjacent slat.

2. Transverse longitudinal joint according to claim 1 wherein each intermediate slat also comprises linking means in the male end and in the female end, comprising:
first protuberances parallel to the main shaft in convex edges of the male end arranged to slide on an internal surface of the female end
second protuberances parallel to the main shaft in free ends of the female end arranged to slide on an external surface of the male end;
having a clearance between:
the first protuberances and the internal surface of the female end;
the second protuberances and the external surface of the male end;
in order to allow a turn between the slats around a shaft parallel to the main shaft and determine a position of minimum overlapping and a position of maximum overlapping of a slat with an adjacent slat.

3. Transverse longitudinal joint according to claim 1, wherein it also comprises a plurality of bars having:
first connecting means to join the bars to intermediate slats on the functional surface by means of a slide having two degrees of freedom without restricting:
a displacement along a shaft parallel to the main shaft;
a turn around a shaft perpendicular to the functional surface of the slat;
second connecting means to join at least two bars to a same end slat on the functional surface by means of first articulations which allow a turn around a shaft perpendicular to the functional surface of the slat;
to form a cohesion mechanism that maintains a distance between slats in each position of the joint.

4. Transverse longitudinal joint according to claim 1, wherein it also comprises a plurality of bars having:
first connecting means to join the bars to intermediate slats on the functional surface by means of a slide having two degrees of freedom without restricting:
a displacement along a shaft parallel to the main shaft;
a turn around a shaft perpendicular to the functional surface of the slat;
second connecting means to join a first bar to a first end slat and a second bar to a second end slat on the functional surface by means of first articulations which allow a turn around a shaft perpendicular to the functional surface of the slats
third connecting means to join a first bar with a second bar in a second articulation to form a cohesion mechanism that maintains a distance between slats in each position of the joint and so that the cohesion mechanism forms a scissors mechanism.

5. Transverse longitudinal joint according to claim 1, wherein it also comprises a plurality of bars having:
first connecting means to join the bars to first intermediate slats on the functional surface by means of a slide having two degrees of freedom without restricting:
a displacement along a shaft parallel to the main shaft;
a turn around a shaft perpendicular to the functional surface of the slat;
fourth connecting means to join the bars to a second intermediate slat on the functional surface by means of a third articulation which allows a turn around a shaft perpendicular to the functional surface of the slat;
to form a cohesion mechanism that maintains a distance between slats in each position of the joint.

6. Transverse longitudinal joint according to claim 3, wherein it also comprises additional cohesion mechanisms arranged in a series, one after the other in perpendicular direction to the main shaft, to cover the length of the joint.

7. Transverse longitudinal joint according to claim 3, wherein it also comprises additional cohesion mechanisms placed in parallel, one after the other in parallel direction to the main shaft, to cover the width of the joint.

8. Transverse longitudinal joint according to claim 1, wherein it also comprises elastic means in the connecting sides arranged to force the joint to adapt itself to the externally imposed length.

9. Transverse longitudinal joint according claim 8 wherein the elastic means are compression/pulling springs crossed by guides which also cross all the slats.

10. Transverse longitudinal joint according to claim 8, wherein the elastic means are selected from elastic means of equal rigidity and elastic means of different rigidity arranged to maintain a homogenous distance between the slats.

11. Transverse longitudinal joint according to claim 1, wherein it also comprises:
a plurality of lateral covers to join at least two slats and obtain linked slats, arranged to avoid a relative displacement of linked slats in the direction of the main shaft.

12. Transverse longitudinal joint of claim 1, wherein it also comprises folding/unfolding means to wind/unwind the joint as a blind comprising:
a winding roller parallel to the main shaft beneath the passable surface arranged to withdraw an excess section of the joint of the retractable surface;
a folding/unfolding guide at each lateral end of the slats in a perpendicular plane to the main shaft to guide the slats in the folding/unfolding process between the winding roller and the retractable surface.

13. Transverse longitudinal joint according to claim 3, wherein it also comprises first supporting means comprising:
a first support joint to the movable surface;
a second support resting on the first support comprising:
a low-friction material layer on which the bars rest.

14. Transverse longitudinal joint according to claim 13 wherein the second support also comprises first interconnection means parallel to the main shaft to interconnect a first pin of the bar.

15. Transverse longitudinal joint according to claim 14 wherein the first pin also comprises a low-friction material ferrule.

16. Transverse longitudinal joint according to claim 3, wherein it also comprises second supporting means comprising:
a third support:
on which the fixed surface rests
a fourth support integrally joined to the third support comprising:
a low-friction material layer on which the bars rest.

17. Transverse longitudinal joint according to claim 16 wherein the fourth support also comprises second interconnection means parallel to the main shaft to interconnect a second pin of the bar and to become the physical stop of the joint, so that a final end of the joint does not move when the bellows structure moves between the unfolded and folded positions.

18. Transverse longitudinal joint according to claim 17 wherein the second pin also comprises a low-friction material ferrule.

19. Transverse longitudinal joint according to claim 18 wherein the second pin also comprises a lock washer which constitutes a latch to avoid a dismantling of the joint by people alien to the installation.

20. A transportation system for carrying people/goods wherein it also comprises a longitudinal joint according to claim 1 in a landing area.
